(19) United States
(12) Patent Application Publication
(10) Pub. No.: US 2003/0153427 A1
(43) Pub. Date: Aug. 14, 2003

(54) Continuously variable automatic transmission

(76) Inventor: Christopher F. Mayranen, East Hartford, CT (US)

Correspondence Address: William B. Ritchie, The Ritchie Law Office, 43 Jackson Street, Concord, NH, 03301, US

(21) Appl. No.: 10/075,740

(22) Filed: Feb. 13, 2002

(51) Int. Cl. F16H 3/74

(52) U.S. Cl. 475/331

(57) ABSTRACT

A gear-type continuously variable automatic transmission that adjusts ratio in response to load. A pair of planetary gear systems with different static ratio properties combined to produce a dynamic, load responsive rotary transmission utilizing the rings or planet carriers of each planetary system as input and output respectively.

### FIELD OF THE INVENTION

This invention relates to the field of automatic continuously varying ratio transmissions, in particular, to an automatic continuously variable transmission using an all-gear configuration.

### BACKGROUND OF THE INVENTION

There are many applications that demand variable ratio transmissions and a variety of systems have been designed for these applications. However, many of these systems have compromised efficiency for ratio control by using belts, brakes and clutches or friction discs. For example, U.S. Pat. Nos. 5,106,353 (issued on Apr. 21, 1992 to Ra et al.) U.S. Pat. No. 4,625,588 (issued on Dec. 2, 1986 to Brickley), and U.S. Pat. No. 3,429,200 (issued on Feb. 25, 1969 to Green) disclose continuously varying transmission devices. The disadvantages of these systems are the requirement of a brake, clutch, torque converter or some other secondary input force necessary to permit continuous variation between gear ratios. They also require a large number of gears and support components, and are therefore cumbersome in manufacture, maintenance and operation.

A few approaches have gained efficiency but are difficult to manufacture and complex. For example, U.S. Pat. Nos. 5,456,640 (issued on Oct. 10, 1995 to Petersen) U.S. Pat. No. 4,625,588 (issued on Apr. 10, 2001 to Hsiao) disclose systems that divide input torque and then recombine it to produce a load sensitive transmission that continuously adjusts output ratio based on load. These systems, though more efficient than the above-mentioned friction based devices, employ bevel type gears which are difficult to manufacture and costly. Bevel type gears also demand a high degree of meshing accuracy which may affect durability cost.

U.S. Pat. No. 5,800,302 (issued on Sep. 1, 1998 to Were) discloses a transmission system that solves many of the above-mentioned problems but includes some disadvantages for specific applications. By utilizing individual sun gears on separate input and output shafts, the system excludes the possibility of one dual-sun gear. By coupling individual sun gears to inputs and outputs, respectively, the system excludes the possibility of using individual ring gears for this purpose. In applications that may not demand inline input and output shafts, but rather concentric inputs and outputs, as in a bicycle hub, this system is not preferable.

Also, because weight savings may be at a premium in some applications, it may be undesirable to use any extra material to bind individual ring gears to rotate in unison, as is done according to the design of this system.

Therefore, there is still a need in the art for a fully geared continuously variable automatic transmission that increases efficiency while decreasing complexity, is not cumbersome to manufacture, maintain and operate, does not produce unwanted ratio changes that would not match the desired curve of the input source, maintains a smooth ratio adjustment as a function of resistance, exhibits quiet operation, and that is highly durable, light weight, and small in size.

### SUMMARY OF THE INVENTION

The present invention is an automatic continuously variable transmission using an all-gear configuration. The transmission includes a drive planetary gear system, which is made up of an input ring gear connected to multiple input drive planet gears. The input drive planet is connected to a dual-sun gear. The transmission further includes a driven planetary gear system which is made up of a dual-sun gear connected to multiple output drive planet gears. The output drive planet gears are connected to an output ring gear. The drive planetary gear system and the driven planetary gear system are each connected to the dual-sun gear. The dual sun gear has a drive side, and a driven side, the drive side is connected to the drive planetary gear system and the driven side is connected to the driven planetary gear system. The drive planetary gear system and the driven planetary gear system have different dimensions.

The present invention additionally includes a carrier element. The carrier element is rotatably mounted to the input and output in between the drive planetary gear assembly and the driven planetary gear assembly. The multiple input drive planet gears and the output drive planet gears are journal led to the carrier element in close relation to the opposing major surfaces thereof

The invention further includes an input shaft connected to the drive planetary gear system and an output shaft connected to the driven planetary gear assembly. An alternate embodiment of the present invention is where the dual-sun gear is replaced by two independent sun gears fixed to a common axle.

Therefore, the present invention is an automatic continuously variable transmission using an all-gear configuration. It has applications in many rotary power transferring devices including vehicle transmissions, optimizing power transmission under various load conditions.

In one form, the transmission is comprised of two basic planetary gear systems utilizing the ring gear of each as input and output, respectively. The sun gear of each system is either one shared dual-gear member or a pair of gears fixed to a common axle. The planet carriers of each system are one unit, or solidly connected to each other. This provides variable torque transfer between the systems, given that each planetary system has a unique turning ratio between its own ring and sun gears. By establishing a ratio response curve to the load demands of an application, the transmission can be configured to automatically vary ratio between input and output rings based on the current load.

As load increases, the input ring will turn increasingly faster than the output ring, producing more torque at the output ring due to reduction gearing through the planet gears of the system. As load diminishes, the planet gears rotate more slowly and the ratio between the ring gears approaches 1:1.

In an alternate form, that closely resembles the above system; the transmission may be configured with individual planet carriers as input and output, respectively. In this case, the two individual ring gears may exist as one combined ring, or be solidly connected.

Therefore, it is an aspect of the present invention to provide a fully geared continuously variable automatic transmission that increases efficiency while decreasing complexity.

It is another aspect of the present invention to provide a fully geared continuously variable automatic transmission that is not cumbersome to manufacture.

It is another aspect of the present invention to provide a fully geared continuously variable automatic transmission that does not produce unwanted ratio changes that would not match the desired curve of the input source.

It is another aspect of the present invention to provide a fully geared continuously variable automatic transmission that is not cumbersome to maintain and operate.

It is another aspect of the present invention to provide a fully geared continuously variable automatic transmission that maintains a smooth ratio adjustment as a function of resistance.

It is another aspect of the present invention to provide a fully geared continuously variable automatic transmission that exhibits quiet operation.

It is another aspect of the present invention to provide a fully geared continuously variable automatic transmission that is small in size.

It is another aspect of the present invention to provide a fully geared continuously variable automatic transmission that is highly durable.

It is another aspect of the present invention to provide a fully geared continuously variable automatic transmission that is light-weight.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

FIG. 1 Illustrates a top down, cross sectional view of the gear type continuously variable transmission with shared dual-sun gear member made in accordance with the principles of the present invention.

FIG. 2 illustrates a side cross sectional view of the transmission with shared dual-sun gear.

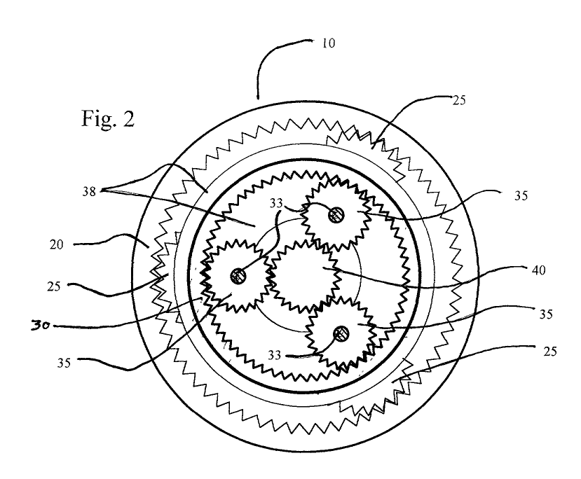

FIG. 3 Illustrates a perspective view of the transmission with shared dual sun gear.

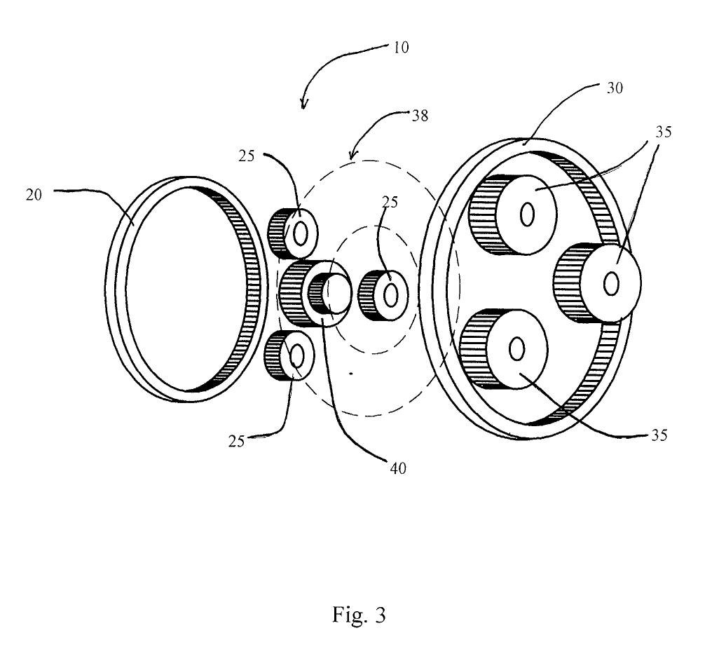

FIG. 4 illustrates an alternate sun gear member using a pair of solidly connected sun gears.

FIG. 5 Illustrates a top down, cross sectional view of an alternate embodiment of the transmission with single drive ring, shared dual sun gear member, and individual planet carrier drives.

As an aid to correlating the terms of the claims to the exemplary drawings the following catalogue of elements is provided:

10 transmission
20 input ring gear
23 input planet gear stub axle
25 input planet gear
30 output ring gear
33 output planet gear stub axle
35 output planet gear
38 shared planet carrier
40 dual-sun gear

### DETAILED DESCRIPTION OF THE INVENTION

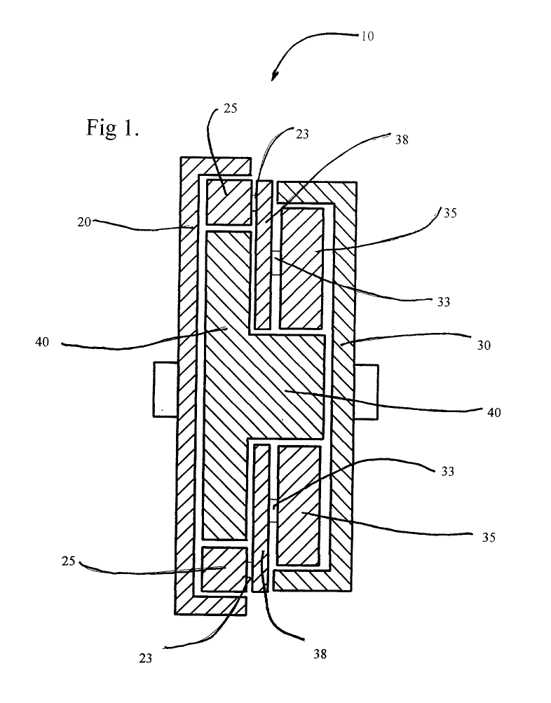

Referring first to FIG. 1, the preferred embodiment of the transmission 10 is shown. The gear arrangement is as follows. Input ring gear 20 is enmeshed with input planet gears 25. Input planet gears 25 are enmeshed with dual-sun gear 40. Input planet gears 25 are mounted for rotation on input planet gear stub axles 23. Input planet gear stub axles 23 are fixed solidly to shared planet carrier 38. Output planet gear stub axles 33 are fixed solidly to shared planet carrier 38. Output planet gears 35 are mounted for rotation on output planet gear stub axles 33. Output planet gears 35 are meshed with dual-sun gear 40 and with output ring gear 30.

The transmission 10, in practice, operates as follows. When input ring gear 20 is rotated at a certain rate while there is zero load at output ring gear 30, all components of the system will rotate in unison at this rate and there will be no difference in rotation speed between the two ring gears 20 and 30. Under this no-load condition, the system can be considered to operate at a 1:1 ratio. This effect is achieved by the configuration of internal planetary gears of the system. If one were to consider two planetary gear systems assembled in the manner of FIG. 1, but with equal dimensions of all components it would be seen that this 1:1 ratio would always be in effect, regardless of load, due to the symmetry of torque transfer through the equal internal gears of the identical planetary gear systems. Therefore, to achieve a ratio variance proportional to load requires that the static ratio or dimensions between sun and ring of each planet gear system differ. Unequal sun, ring and planet radii can achieve this.

Still referring to FIG. 1, as load increases at output ring gear 30, the input ring gear 20 will rotate at a higher rate than output ring gear 30, in proportion to this load. Dual-sun gear 40 will rotate in the opposite direction to input ring gear 30 with increasing speed as load increases. Although it appears that slippage is occurring between the two ring gears 20 and 30, actually load sensitive reduction gearing and torque transfer through the planet and sun gears of both systems is occurring. A speed increase of input ring gear 20 relative to output ring gear 30 produces a torque increase at output gear 30.

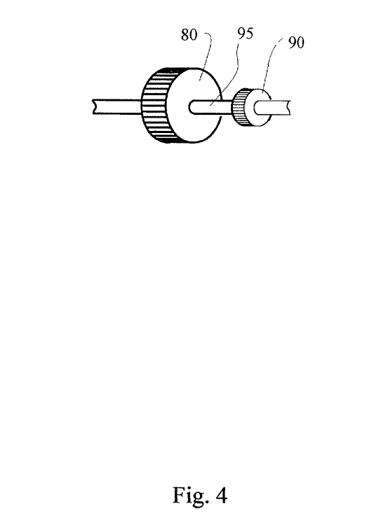

Referring now to FIG. 4, an alternate embodiment of the dual-sun gear 40, shown in FIG. 1, is shown The dual-sun gear 40 is replaced by a solidly connected pair of sun gears 80 and 90, which are solidly mounted onto axle 95. Depending on applications where weight, cost, or space savings are a consideration, either a dual-sun gear, or two individual sun gears fixed to a common axle may be employed.

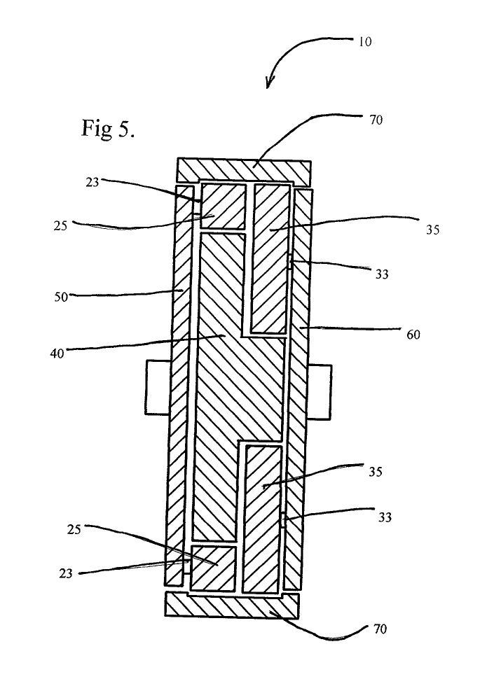

Another alternative embodiment to the present invention is shown in FIG. 5. The transmission is shown using a single ring gear 70, an input planet drive carrier 50, and an output planet drive carrier 60, with the corresponding other elements labeled as in FIG. 1. Operation of the system is similar to the system shown in FIG. 1, except that here individual planet carriers are used as input and output rather than individual ring gears. In this configuration, it is necessary to fix individual ring gears from rotating relative to each other, or control their relative rotation, or provide a single ring gear 70, as is illustrated in FIG. 5.

Additionally, there are other possible embodiments of the present invention. By varying the radii of the ring, planet and sun gears in the system, various load responsive ratio curves can be produced. Dynamic ratio variance is a function of the static ratio difference between the two planetary gear systems.

Embodiments that include more or less parts can also be provided. Further, a variety of materials used are also possible. Both possibilities are within the scope of this invention. A variety of gear arrangements and gear types exist and can optimize the system for many detailed applications. In addition, various housing and bearing configurations and a variety of materials may be employed in the manufacture of the system. Suitable bearings may be provided for any rotating part in the system. The system might be mounted on an axle which passes through and is fixed to the sun gear(s). Each ring gear might be integral or associated with another part, such as the wheel hub and drive sprocket of a bicycle. Likewise, if planet carriers are used as input and output drives, each planet carrier may be integral or associated with input and output drive components.

Other embodiments include a torque converter/clutch as input intervention. In order to disengage an input source from the present invention transmission, it may be accompanied by some configuration of clutch, torque converter, lock-up type torque converter or other intervening device. Additionally, alternative embodiments also include more or less planet gears and other planet gear carrier arrangements may be configured to the system.

Also, another embodiment is created in FIG. 1, if shared planet carrier 38 is replaced with individual solidly connected elements for each pair of corresponding input and output planet gears 25 and 35. In this way, an extremely light shared carrier arrangement may be provided using minimal material and lowering rotating inertia

Enhanced ratio control methods are possible with the present invention. An external controlling device may be used to manipulate the sun or ring or planet gear(s) of the system, which might further refine ratio response for specific applications.

Another embodiment involving a single drive ring is presented in the present invention. When the transmission is configured with individual planet carriers as input and output, it becomes necessary to create a single drive ring, or two individual rings solidly connected. An advantage to a single ring is a reduction in cost and weight, a consideration for bicycle applications and other areas where this is critical.

The present invention has many advantages compared to the prior art. In applications where input source torque production curves are known, this system can be designed with gear configurations that maintain optimal efficiency and performance of this input source. Under loading, an input rate can be held smoothly within an optimal range of torque production rates, rather than drastically fluctuate in the manner of current stepped transmission systems. Sudden source rate changes, particularly in internal combustion engines, upset efficiency by creating surge conditions under which fuel is wasted. Smooth input rate changes also result in safer operating conditions that do not upset the handling balance of a vehicle.

Disruptions of this kind in wet or other adverse conditions can result in loss of traction. Smooth rate changes can also be made quieter than stepped systems.

More efficiency gains may result from the system being geared such that the final output ratio of 1:1 is never attained, yet always advanced toward as resistance diminishes. This provides a continuously optimizing efficiency.

By eliminating all associated linkages and gear change mechanisms, weight and complexity is reduced and manufacturing ease is increased. Because there are few parts overall, the system can be made small, light and easy to manufacture. By simplifying the current transmission to employ a single ring gear, a dual sun gear and individual plant carrier drives, as shown in FIG. 5, further weight and cost reduction is achieved. Finally, the sturdiness of the planetary gear system design contributes excellent durability by distributing gear wearing forces evenly.

The present invention has many applications in the industry. This transmission could be used in motor vehicles, bicycles, appliances, marine and aviation systems, heavy and light machinery, electrical power generation systems, and any other system that would benefit from optimal rotary power transmission.

Although the present invention has been described with reference to certain preferred embodiments thereof, other versions are readily apparent to those of ordinary skill in the art. Therefore, the spirit and scope of the appended claims should not be limited to the description of the preferred embodiments contained herein.

what is claimed is:

1. An automatic continuously variable transmission using an all-gear configuration, said transmission comprising:
a drive planetary gear system comprising an input ring gear in meshing relation to a plurality of input drive planet gears, said input drive planet gears are in meshing engagement to a dual-sun gear;
a driven planetary gear system comprising a dual-sun gear in meshing engagement to a plurality of output drive planet gears, said output drive planet gears in meshing engagement to an output ring gear; and
wherein said drive planetary gear system, and said driven planetary gear system are each connected to said dual-sun gear, said dual sun gear having a drive side, and a driven side, said drive side being in meshing relation to said drive planetary gear system, said driven side being in meshing engagement to said driven planetary gear system.

2. The automatic continuously variable transmission claimed in claim 1, wherein said drive planetary gear system and said driven planetary gear system having different dimensions.

3. The automatic continuously variable transmission claimed in claim 2, further comprising:
a carrier element rotatably mounted to said input and output intermediate said drive planetary gear assembly and said driven planetary gear assembly;
wherein said plurality of input drive planet gears and said output drive planet gears are journal led to said carrier element proximate opposing major surfaces thereof,
whereby said carrier element intercouples said drive planetary gear assembly to said driven planetary gear assembly.

4. The automatic continuously variable transmission claimed in claim 3, wherein said drive planetary gear system is driven by an input shaft.

5. The automatic continuously variable transmission claimed in claim 4, wherein said driven planetary gear system is connected to an output shaft.

6. An automatic continuously variable transmission using an all-gear configuration, said transmission comprising:
a drive planetary gear system comprising an input ring gear in meshing relation to a plurality of input drive planet gears, said input drive planet are in meshing engagement to a drive sun gear; and
a driven planetary gear system comprising a driven sun gear in meshing engagement to a plurality of output drive planet gears, said output drive planet gears in meshing engagement to an output ring gear,
wherein said drive sun gear and said driven sun gear are fixedly attached to a common axle forming a dual-sun gear, and wherein said drive planetary gear system, and said driven planetary gear system are connected through said dual-sun gear.

7. The automatic continuously variable transmission claimed in claim 6 wherein said drive planetary gear system and said driven planetary gear system having different dimensions.

8. The automatic continuously variable transmission claimed in claim 7, further comprising:
a carrier element rotatably mounted to said input and output intermediate said drive planetary gear assembly and said driven planetary gear assembly where said plurality of input drive planet gears and said output drive planet gears are journal led to said carrier element proximate opposing major surfaces thereof,
whereby said carrier element intercouples said drive planetary gear assembly to said driven planetary gear assembly.

9. The automatic continuously variable transmission claimed in claim 8 wherein said drive planetary gear system is driven by an input shaft.

10. The automatic continuously variable transmission claimed in claim 9, wherein said driven planetary gear system is connected to an output shaft.

11. An automatic continuously variable transmission using an all-gear configuration, said transmission comprising:
a drive planetary gear system comprising a drive carrier in meshing relation to a plurality of input drive planet gears, said input drive planet gears are in meshing engagement to a dual-sun gear and a ring gear;
a driven planetary gear system comprising a dual-sun gear in meshing engagement to a plurality of output drive planet gears, said output drive planet gears in meshing engagement with a driven carrier and said ring gear; and
wherein said drive planetary gear system, and said driven planetary gear system are each connected to said dual-sun gear, said dual sun gear having a drive side, and a driven side, said drive side being in meshing relation to said drive planetary gear system, said driven side being in meshing engagement to said driven planetary gear system, and wherein said drive planetary gear system, and said driven planetary gear system are in meshing engagement with said ring gear.

12. The automatic continuously variable transmission claimed in claim 11, wherein said drive planetary gear system is driven by an input shaft.

13. The automatic continuously variable transmission claimed in claim 12, wherein said driven planetary gear system is connected to an output shaft.
